(19) United States
(12) Patent Application Publication
(10) Pub. No.: US 2021/0364239 A1
(43) Pub. Date: Nov. 25, 2021

(54) BUFFER STORAGE ARRANGEMENT FILLED WITH PHASE CHANGE MATERIAL

(71) Applicant: HeatVentors Kft, Mezotur (HU)

(72) Inventors: Zoltan Andrassy, Budapest (HU); Farkas Rita Andrassyne, Budapest (HU)

(21) Appl. No.: 17/053,145

(22) PCT Filed: May 8, 2019
(86) PCT No.: PCT/HU2019/000012

§ 371 Date: Nov. 5, 2020

(30) Foreign Application Priority Data
May 11, 2018 (HU) P1800157

(51) Int. Cl. F28D 20/02; F28F 1/24

(52) U.S. Cl. CPC F28D 20/021; F28F 1/24

(57) ABSTRACT

The invention relates to a buffer storage arrangement filled with phase change material for storing heat energy, comprising a container (1) having open or sealed configuration, a heat exchanger unit (2) arranged in the container (1), and liquid-solid phase change material encompassing the heat exchanger unit (2) inside the container (1), wherein the heat exchanger unit (2) comprises pipe coils (21, 22) formed from bent pipes and heat exchanger fins (23) adapted for interconnecting the pipe coils (21, 22), wherein each pipe coil (21, 22) is situated along a respective imaginary plane, the imaginary planes being arranged parallelly beside one another, and the heat exchanger fins (23) are arranged aligned with the cross-sectional (24) direction of the pipes of the pipe coils (21, 22), substantially perpendicular to the imaginary planes of the pipe coils. The arrangement according to the invention is characterized in that the cross-sectional area of the container (1) is essentially filled by the heat exchanger fins (23) such that fluid communication between the walls (11, 12, 13, 14) of the container (1) and the heat exchanger unit (2) is provided in order to balance inhomogeneities between the spatial regions (15) separated by the heat exchanger fins (23).

### TECHNICAL FIELD

The invention relates to a buffer storage arrangement filled with phase change material that is adapted for storing and releasing waste heat or other type of heat energy.

### BACKGROUND ART

The document WO 2017/020566 A1 discloses a phase change heat storage device comprising a housing, a liner provided inside the housing, an insulation layer provided between the liner and the housing, a phase change material filled inside the liner, a coil pipe provided within the phase change material, an inlet and an outlet of the coil pipe extending to the outside of the liner, and being respectively welded to and communicating with a main water inlet pipe and a main water outlet pipe, such that welding points between the coil pipe and the main water inlet pipe and the main water outlet pipe are all disposed outside of the liner, and are not immersed in the phase change material. At least one separation plate is provided in the liner, the separation plate dividing the liner inner portion into independent spaces. Compared to the state of the art the arrangement and configuration of the device is simple, while it greatly improves the efficiency of heat exchange, reducing manufacturing costs and increasing the service life of the device.

The document EP 3252418 A1 discloses a heat exchanger device comprising tubing for receiving and delivering a heat transfer fluid. The tubing is encompassed by a phase change material (PCM) that is received in multiple cells such that the flow of the heat transfer fluid in said tubing causes the phase change material (PCM) to change phase gradually, from cell to cell, in the direction of the inlet to the outlet. The cells may have an open or sealed configuration, the tubing may comprise fins, and the heat exchanger has an external container adapted for storing the PCM. The heat exchanger may comprise a second tubing for receiving and delivering a second heat transfer fluid, wherein the second tubing is connected to the PCM cells and/or to the fins of the first tubing, such that heat is transferred between the first tubing and the second tubing as each the PCM gradually changes phase.

The disadvantage of the known technical solutions is that the phase change material cannot flow freely because of the mutually separated independent spatial regions, so during heat storage the solid-phase material appears in separate spatial regions. Another disadvantage of the known technical solutions is that due to the density difference resulting from phase change the volume of the material contained in the cells varies over time. Mechanical stresses caused by the volume change can damage the container. Due to the above cell-type arrangement the efficiency of known buffer storage devices is lower and the devices have more complex configuration.

### DISCLOSURE OF THE INVENTION

The objective of the present invention is to provide a buffer storage arrangement that allows the phase change heat storage material to freely move over the entire internal volume of the arrangement, thus improving heat storage efficiency, providing an alternative geometrical configuration for buffer storage devices and widening their scope of application.

The objective of the invention is realized by providing a buffer storage arrangement filled with phase change material comprising a container having open or sealed configuration, a heat exchanger unit arranged in the container, and liquid-solid phase change material encompassing the heat exchanger unit inside the container, wherein the heat exchanger unit comprises pipe coils formed from bent pipes and heat exchanger fins adapted for interconnecting the pipe coils, wherein each pipe coil is situated along a respective imaginary plane, the imaginary planes being arranged parallelly beside one another, and the heat exchanger fins are arranged aligned with the cross-sectional direction of the pipes of the pipe coils, substantially perpendicular to the imaginary planes of the pipe coils, wherein the cross-sectional area of the container is essentially filled by the heat exchanger fins such that fluid communication between the walls of the container and the heat exchanger unit is provided in order to balance inhomogeneities between the spatial regions separated by the heat exchanger fins.

In a preferred embodiment of the buffer storage arrangement according to the invention the walls of the container and the heat exchanger fins of the heat exchanger unit are mutually spaced apart.

In another preferred embodiment of the buffer storage arrangement according to the invention the heat exchanger fins of the heat exchanger unit comprise through holes or cutouts that are arranged along the walls of the container and extend between the spatial regions separated by the fins.

In a further preferred embodiment of the buffer storage arrangement according to the invention the distance between adjacent pipes is identical in both substantially mutually perpendicular transverse directions.

In a preferred embodiment of the buffer storage arrangement according to the invention, shoulders adapted for providing a uniform distance between the fins are disposed on the heat exchanger fins around the pipes, the shoulders being formed of material originating from perforations made for the pipes passed therethrough.

In a further preferred embodiment of the buffer storage arrangement according to the invention the uniform distance between the heat exchanger fins is preferably between 2.1 and 6 mm.

In a subsequent preferred embodiment of the buffer storage arrangement according to the invention, the heat exchanger fins have an undulating surface configuration.

In a preferred embodiment of the buffer storage arrangement according to the invention every second pairs of mutually parallelly arranged pipe coils are interconnected to form a primary circuit, wherein the primary circuit further comprises a primary distribution pipe to which the inlets of the pipe coils forming the primary circuit are connected and a primary manifold, to which the outlets of the pipe coils forming the primary circuit are connected, and wherein the pipe coils situated between the pipe coils of the primary circuit form a secondary circuit, the secondary circuit further comprising a secondary distribution pipe to which the inlets of the pipe coils forming the secondary circuit are connected and a secondary manifold to which the outlets of the pipe coils forming the secondary circuit are connected, with a primary heat-transfer medium and a secondary heat-transfer medium, disposed in the primary circuit and the secondary circuit, respectively, being circulated in a counter-flow fashion through the pipe coils.

In a further preferred embodiment of the buffer storage arrangement according to the invention the primary distribution pipe, the secondary distribution pipe, the primary manifold and the secondary manifold are configured such that there is an identical volumetric flow through all the parallel pipe coils.

In another preferred embodiment of the buffer storage arrangement according to the invention the container has a rectangular block shape.

In a subsequent preferred embodiment of the buffer storage arrangement according to the invention the walls of the container comprise a heat-insulating layer.

In a further preferred embodiment of the buffer storage arrangement according to the invention the buffer storage arrangement is connected to a heat transfer system via a three-way valve.

### BRIEF DESCRIPTION OF DRAWINGS

In the following the buffer storage arrangement according to the invention is described in detail referring to the accompanying drawings and reference numerals, where

FIG. 1 is a schematic view of the buffer storage arrangement filled with phase change material,

FIG. 2 is the schematic depiction of the heat exchanger unit of the buffer storage arrangement filled with phase change material,

FIG. 3 shows the arrangement of the pipes of the heat exchanger unit according to FIG. 2, and

FIG. 4 is a sectional view, taken along the same plane as a cross-section of the pipes of the buffer storage arrangement filled with phase change material.

### BEST MODE OF CARRYING OUT THE INVENTION

The buffer storage arrangement according to the invention illustrated in FIG. 1 comprises a container 1 and a heat exchanger unit 2 disposed in the container 1. The container 1 is filled with a phase change material that is capable of storing excess heat, or of providing a missing amount of heat, with respect to an appropriate target value by means of change from a solid to a liquid state under the predetermined operating conditions of the buffer storage arrangement. The container 1 preferably has a rectangular block-shaped configuration.

In the buffer storage arrangement according to the invention the pressure differential resulting from temperature differences can be balanced in different ways. According to a preferred aspect of the invention, the internal space and external space of the container 1 are in fluid communication, for example via a through hole or a backward bent pipe 16. The backward bent pipe 16 is disposed such that in the operating position the phase change material cannot leak out from the container 1, but air can freely escape from the container 1. The backward curve of the backward bent pipe 16 is required such that dust or contamination cannot reach the phase change material.

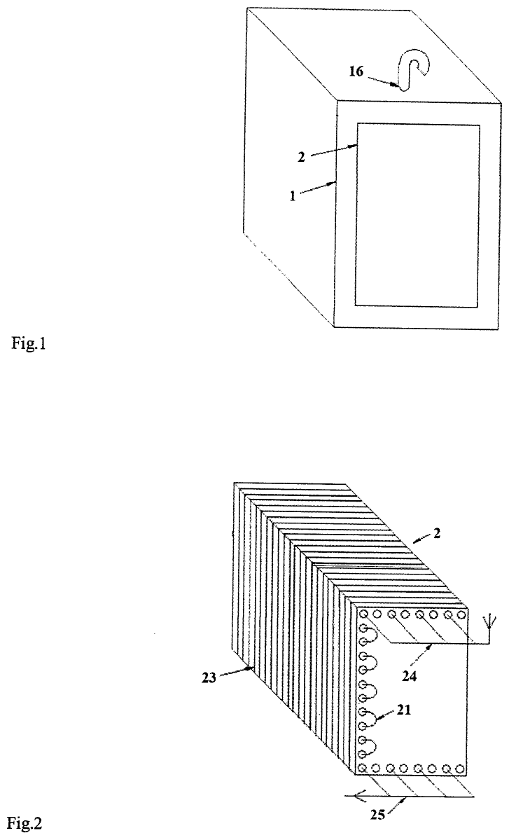

In FIG. 2 the operation of the heat exchanger unit 2 of the buffer storage arrangement according to the invention is illustrated schematically. The heat exchanger unit 2 comprises pipe coils formed from bent pipes and heat exchanger fins adapted for interconnecting the pipe coils. The pipe coils are essentially configured such that each pipe is bent in alternate directions along a given plane such that its straight sections extend under one another parallel with each other, and both ends of the pipe are situated on the same side. In another embodiment, the pipe ends can be arranged on opposite sides. The pipe can be made of copper, aluminium, or other material with favorable heat conductivity characteristics. Each pipe coil 21, 22 fashioned accordingly is situated along a respective imaginary plane, the imaginary planes being arranged parallel beside one another. Seen in a plane perpendicular to the pipes of the heat exchanger unit 2 the distance between the pipes is identical in all directions. The relative position of the pipes is secured by heat exchanger fins 23 disposed between the pipes. The heat exchanger fins 23 are arranged corresponding to the cross-sectional direction of the pipes of the pipe coils 21 and 22, i.e. essentially perpendicular to the imaginary plane of the pipe coils 21 and 22. The heat exchanger fins 23 are configured to essentially correspond to the cross-sectional shape of the container 1. The fins are made of a material with favorable heat conduction characteristics, for example aluminium, copper, or other known alloy. To increase the heat transfer surface area, the heat exchanger fins 23 can have an undulating surface configuration.

The heat exchanger fins 23 are connected to the pipe coils 21 and 22 by way of perforations disposed on the heat exchanger fins 23 that correspond in size to the diameter of the pipes of the pipe coils 21 and 22, with the pipe coils 21 and 22 being passed through the perforations. The perforations also provide that a uniform distance can be kept between the pipes.

The distance between the heat exchanger fins 23 is preferably between 2.1 and 6 mm. To maintain the distance between the heat exchanger fins 23 and also to improved heat transfer, the heat exchanger fins 23 can also be perforated such that the material is not removed from the perforations but a partial or full circumferential rim is formed therefrom that can function as a spacer shoulder adapted to keep the distance between the heat exchanger fins 23.

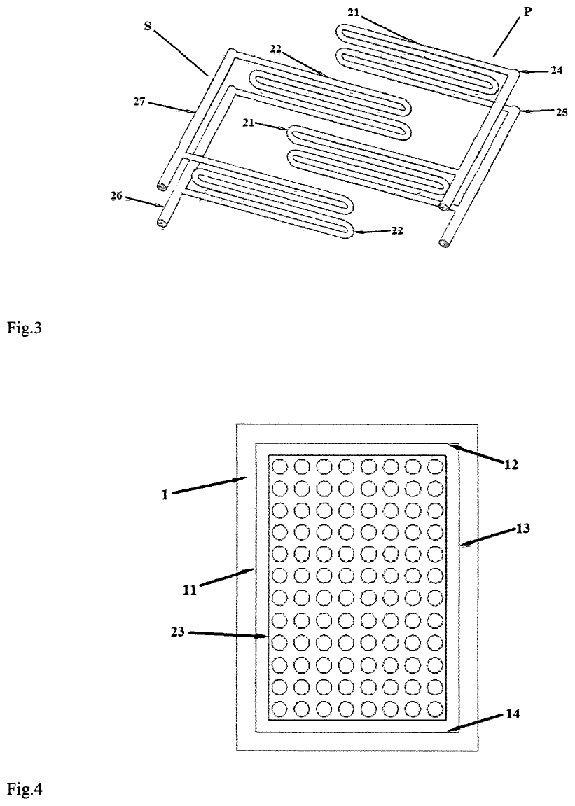

As can be seen in FIG. 3, a preferred embodiment of the heat exchanger unit 2 comprises two different flow circuits. These will be hereinafter referred to as the primary circuit P and the secondary circuit S. The primary circuit P is constituted by the first, third, etc. pipe coils 21 or by the second, fourth, etc. pipe coils (counting them either from the left or the right of the figure), while the secondary circuit S is constituted by the pipe coils 22 situated between those of the primary circuit P.

In addition to the pipe coils 21, the primary circuit P also comprises a primary distribution pipe 24 and a primary manifold 25. The pipe coils 21 are arranged in the heat exchanger unit 2 such that the primary heat transfer medium entering through the primary distribution pipe 24 flows through the pipe coils 21 as far as the primary manifold 25, where it exits the heat exchanger unit 2. The quantity of the heat transfer medium flowing through the pipe coils 21 is essentially identical in all pipe coils 21. This is ensured in a manner known per se, by way of example applying three-way valves.

In addition to the pipe coils 22, the secondary circuit S also comprises a secondary distribution pipe 26 and a secondary manifold 27. The pipe coils 22 are arranged in the heat exchanger unit 2 such that the secondary heat transfer medium entering through the secondary distribution pipe 25 flows through the pipe coils 22 as far as the secondary manifold 27, where it exits the heat exchanger unit 2. The quantity of the heat transfer medium flowing through the pipe coils 22 is essentially identical in all pipe coils 22. This is ensured in a manner known per se, by way of example applying baffle plates.

The primary circuit P and the secondary circuit S are thus situated opposite each other, in a comb-like intertwined manner, thereby providing counter-flow heat exchange. The primary circuit P and the secondary circuit S of the heat exchanger unit of the buffer storage arrangement 2 are built into a previously selected heat transfer system in a manner know per se, applying a system of valves.

In the a preferred embodiment depicted in FIG. 4 the heat exchanger unit 2 is arranged in the container 1 such that the inhomogeneities between the spatial regions separated by the heat exchanger fins 23 are balanced through fluid communication between the walls 11, 12, 13, 14 of the container 1 and the heat exchanger fins 23 of the heat exchanger unit 2, preferably by applying a spacing between the walls 11, 12, 13, 14 and the edges of the heat exchanger fins 23, or by disposing cutouts arranged on the heat exchanger fins 23 along the walls 11, 12, 13, 14.

The advantage of the buffer storage arrangement according to the invention is that it can be manufactured at a lower cost compared to known technical solutions with a similar purpose, while it offers a simpler solution that also improves the heat transfer efficiency of the heat storage arrangement, and can be utilized as a universally applicable, variable-size means for medium-term heat storage in heat transfer systems.

### LIST OF REFERENCE NUMERALS

1—container
11—wall
12—wall
13—wall
14—wall
16—backward bent pipe
2—heat exchanger unit
21—pipe coil
22—pipe coil
23—heat exchanger fin
24—primary distribution pipe
25—primary manifold
26—secondary distribution pipe
27—secondary manifold
P—primary circuit
S—secondary circuit

1. Buffer storage arrangement filled with phase change material for storing heat energy, comprising a container (1) having open or sealed configuration, a heat exchanger unit (2) arranged in the container (1), and liquid-solid phase change material encompassing the heat exchanger unit (2) inside the container (1), wherein the heat exchanger unit (2) comprises pipe coils (21, 22) formed from bent pipes and heat exchanger fins (23) adapted for interconnecting the pipe coils (21, 22), wherein each pipe coil (21, 22) is situated along a respective imaginary plane, the imaginary planes being arranged parallel beside one another, and the heat exchanger fins (23) are arranged aligned with the direction of the cross-section of the pipes of the pipe coils (21, 22), substantially perpendicular to the imaginary planes of the pipe coils,
characterized in that the cross-sectional area of the container (1) is essentially filled by the heat exchanger fins (23) such that fluid communication between the walls (11, 12, 13, 14) of the container (1) and the heat exchanger unit (2) is provided in order to balance inhomogeneities between the spatial regions (15) separated by the heat exchanger fins (23).

2. The buffer storage arrangement according to claim 1, characterized in that the walls (11, 12, 13, 14) of the container (1) and the heat exchanger fins (23) of the heat exchanger unit (2) are spaced apart with respect to each other.

3. The buffer storage arrangement according to claim 1, characterized in that the heat exchanger fins (23) of the heat exchanger unit (2) comprise through holes or cutouts that are arranged along the walls (11, 12, 13, 14) of the container (1) and extend between the spatial regions (15) separated by the fins.

4. The buffer storage arrangement according to one of the preceding claims, characterized in that the distance between adjacent pipes is identical in both substantially mutually perpendicular transverse directions.

5. The buffer storage arrangement according to one of the preceding claims, characterized in that shoulders adapted for providing a uniform distance between the fins (23) are disposed on the heat exchanger fins (23) around the pipes, the shoulders being formed of material originating from perforations made for the pipes passed therethrough.

6. The buffer storage arrangement according to one of the preceding claims, characterized in that the uniform distance between the heat exchanger fins (23) is preferably between 2.1 and 6 mm.

7. The buffer storage arrangement according to one of the preceding claims, characterized in that the heat exchanger fins (23) have an undulating surface configuration.

8. The buffer storage arrangement according to one of the preceding claims, characterized in that every second pairs of mutually parallelly arranged pipe coils (21) are interconnected to form a primary circuit (P), wherein the primary circuit (P) further comprises a primary distribution pipe (24) to which the inlets of the pipe coils (21) forming the primary circuit (P) are connected and a primary manifold (25), to which the outlets of the pipe coils (21) forming the primary circuit (P) are connected, and wherein the pipe coils (22) situated between the pipe coils (21) of the primary circuit (P) form a secondary circuit (S), the secondary circuit (S) further comprising a secondary distribution pipe (26) to which the inlets of the pipe coils (22) forming the secondary circuit (S) are connected and a secondary manifold (27) to which the outlets of the pipe coils (22) forming the secondary circuit (S) are connected, with a primary heat-transfer medium and a secondary heat-transfer medium, disposed in the primary circuit (P) and the secondary circuit (S), respectively, being circulated in a counter-flow fashion through the pipe coils (21, 22).

9. The buffer storage arrangement according to claim 8, characterized in that the primary distribution pipe (24), the secondary distribution pipe (26), the primary manifold (25) and the secondary manifold (25) are configured such that there is an identical volumetric flow through all the parallel pipe coils (21, 22).

10. The buffer storage arrangement according to one of the preceding claims, characterized in that the container (2) has a rectangular block shape.

11. The buffer storage arrangement according to one of the preceding claims, characterized in that the walls (11, 12, 13, 14) of the container (2) comprise a heat-insulating layer.

12. The buffer storage arrangement according to one of the preceding claims, characterized in that the buffer storage arrangement is connected to a heat transfer system via a three-way valve.
